(19) United States
(12) Patent Application Publication
(10) Pub. No.: US 2025/0012975 A1
(43) Pub. Date: Jan. 9, 2025

(54) QUANTUM SIMULATOR USING FIBER LOOPS

(71) Applicant: CORNING INCORPORATED, CORNING, NY (US)

(72) Inventors: David August Sniezek Loeber, Horseheads, NY (US); William James Miller, Horseheads, NY (US); Daniel Aloysius Nolan, Corning, NY (US)

(21) Appl. No.: 18/711,741

(22) PCT Filed: Nov. 7, 2022
(86) PCT No.: PCT/US22/49122

§ 371 Date: May 20, 2024

Related U.S. Application Data
(60) Provisional application No. 63/281,779, filed on Nov. 22, 2021.

(51) Int. Cl. G02B 6/27; G06N 10/20

(52) U.S. Cl. CPC G02B 6/2766; G06N 10/20

(57) ABSTRACT

A quantum circuit is presented. The quantum circuit includes a polarization dependent coupler optically coupled to a quantum source and a fiber loop, a polarization controller optically coupled to the fiber loop, wherein the polarization controller is configured to switch a polarization of a photon traversing the fiber loop, and a detector coupler optically coupled to the fiber loop and optically coupled to a photon detector.

### CROSS-REFERENCE TO RELATED APPLICATIONS

This application claims the benefit of priority under 35 U.S.C. § 119 of U.S. Provisional Application No. 63/281,779 filed Nov. 22, 2021, the content of which is incorporated herein by reference in its entirety.

### FIELD

The present specification generally relates to quantum circuits. More specifically, the present disclosure relates to a quantum simulator using fiber loops.

### BACKGROUND

Quantum simulators are specialized quantum computers that are designed to solve a general class of specific problems such as optimization problems, molecular design problems, or quantum machine learning applications. These types of problems cannot be efficiently solved with classical computers. However, a quantum simulator may be able to efficiently solve these types of problems by performing quantum computations.

Photonic optical circuits have been proposed to perform the quantum computations needed to solve these types of problems. However, these circuits are typically too lossy for quantum computing and are typically limited in connectivity. Accordingly, a need exists for improved quantum circuits.

### SUMMARY

According to a first aspect of the present disclosure, a quantum circuit may include a polarization dependent coupler, a polarization controller, and a detector coupler. The polarization dependent coupler may be optically coupled to a quantum source and a fiber loop. The polarization controller may be optically coupled to the fiber loop and may be configured to switch a polarization of a photon traversing the fiber loop. A detector coupler may be optically coupled to the fiber loop and optically coupled to a photon detector.

A second aspect includes the quantum circuit of the first aspect, and may further include an electronic switch to disengage the polarization controller.

A third aspect includes the quantum circuit of any preceding aspect, wherein the fiber loop is optically coupled to both a first loop end of the polarization dependent coupler and a second loop end of the polarization dependent coupler.

A fourth aspect includes the quantum circuit of the third aspect, wherein the polarization dependent coupler further includes a portal end optically coupled to the quantum source, the polarization dependent coupler is configured to direct photons comprising a first polarization between the portal end and the first loop end and between the second loop end and the portal end, and the polarization dependent coupler is configured to direct photons comprising a second polarization between the second loop end and the first loop end.

A fifth aspect includes the quantum circuit of any preceding aspect, wherein the fiber loop comprises a delay region.

A sixth aspect includes the quantum circuit of the fifth aspect, wherein the delay region comprises a fiber delay line.

A seventh aspect includes the quantum circuit of the firth aspect, wherein the delay region comprises a quantum memory.

An eighth aspect includes the quantum circuit of the seventh aspect, wherein the quantum memory is configured to absorb a photon representing a quantum state and release a photon comprising the quantum state of the absorbed photon.

A ninth aspect includes the quantum circuit of any preceding aspect, wherein the quantum source is a single photon source.

A tenth aspect includes the quantum circuit of any of the first through eighth aspects, wherein the quantum source is a multi-photon source configured to output pairs of entangled photons.

An eleventh aspect includes the quantum circuit of any of the first through eighth aspects, wherein the quantum source is configured to output a train of squeezed optical pulses.

A twelfth aspect includes the quantum circuit of any preceding aspect, wherein the fiber loop comprises a first fiber loop and the quantum circuit further comprises a second fiber loop optically coupled to the first fiber loop by a fiber loop coupler.

A thirteenth aspect includes the quantum circuit of the twelfth aspect, wherein the second fiber loop comprises a second detection coupler optically coupled to the second fiber loop and optically coupled to a second photon detector.

A fourteenth aspect includes the quantum circuit of any of the twelfth through thirteenth aspects, wherein the second fiber loop comprises a second delay region.

According to a fifteenth aspect of the present disclosure, a method of controlling photon propagation in a quantum circuit may include directing a photon comprising a first polarization from a quantum source through a polarization dependent coupler and into a fiber loop, switching the polarization of the photon from the first polarization to a second polarization, using a polarization controller that is optically coupled to the fiber loop, during a first pass of the photon through the polarization controller such that the photon travels through the polarization dependent coupler and remains in the fiber loop for a second pass through the polarization controller, and disengaging the polarization controller prior to the second pass of the photon through the polarization controller such that the photon remains in the second polarization.

A sixteenth aspect includes the method of the fifteenth aspect, further comprising disengaging the polarization controller using an electronic switch.

A seventeenth aspect includes the method of any of the fifteenth through sixteenth aspects, wherein the fiber loop is optically coupled to both a first loop end of the polarization dependent coupler and a second loop end of the polarization dependent coupler.

An eighteenth aspect includes the method of the seventeenth aspect, wherein the polarization dependent coupler comprises a portal end optically coupled to the quantum source, the polarization dependent coupler is configured to direct photons comprising the first polarization between the portal end and the first loop end and between the second loop end and the portal end, and the polarization dependent coupler is configured to direct photons comprising the second polarization between the second loop end and the first loop end.

A nineteenth aspect includes the method of any of the fifteenth through eighteenth aspects, further comprising delaying the photon using a delay region of the fiber loop between the first pass and the second pass of the photon through the polarization controller.

A twentieth aspect includes the method of the nineteenth aspect, wherein the delay region comprises a fiber delay line.

A twenty-first aspect includes the method of the nineteenth aspect, wherein the delay region comprises a quantum memory.

A twenty-second aspect includes the method of the twenty-first aspect, wherein the quantum memory is configured to absorb a photon representing a quantum state and release a photon comprising the quantum state of the absorbed photon.

A twenty-third aspect includes the method of any of the fifteenth through twenty-second aspects, wherein the quantum source is a single photon source.

A twenty-fourth aspect includes the method of any of the fifteenth through twenty-second aspects, wherein the quantum source is a multi-photon source configured to output pairs of entangled photons.

A twenty-fifth aspect includes the method of any of the fifteenth through twenty-second aspects, wherein the quantum source is configured to output a train of squeezed optical pulses.

A twenty-sixth aspect includes the method of any of the fifteenth through twenty-fifth aspects, further comprising directing the photon from the fiber loop to a photon detector using a detector coupler optically coupled to the fiber loop, and measuring a quantum property of the photon using the photon detector.

A twenty-seventh aspect includes the method of any of the fifteenth through twenty-sixth aspects, wherein the fiber loop is a first fiber loop that is optically coupled to a second fiber loop by a fiber loop coupler and the method further comprises directing the photon from the first fiber loop to the second fiber loop using the fiber loop coupler.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 schematically depicts a quantum circuit comprising a single fiber loop, according to one or more embodiments shown and described herein;

FIG. 2 schematically depicts a quantum circuit comprising two fiber loops, according to one or more embodiments shown and described herein;

FIGS. 3A and 3B schematically depicts a polarization controller, according to one or more embodiments shown and described herein;

FIG. 4 schematically depicts a quantum circuit comprising four fiber loops, according to one or more embodiments shown and described herein; and

FIG. 5 depicts an example method of operating the quantum circuit of FIG. 1, according to one or more embodiments shown and described herein.

### DETAILED DESCRIPTION

Reference will now be made in detail to embodiments of a quantum circuit, embodiments of which are illustrated in the accompanying drawings. Whenever possible, the same reference numerals will be used throughout the drawings to refer to the same or like parts.

Quantum walks have been proposed as a method to simulate quantum phenomena and perform quantum simulation in general. This method of quantum computing is useful for not only optical quantum platforms, but also other platforms including semiconductor and ion trapped quantum computing. Optical methods have advantages in that quantum optical propagation can occur over long distances within low loss media without losing quantum properties such as entanglement.

However, photons are difficult to actively manipulate. For this reason, passive circuit designs such as passive optical waveguides are often considered. In one example, Boson sampling in a planar waveguide has been proposed for quantum simulation. However, this may require the simultaneous firing of 50 single photon sources into a passive planar waveguide composed of an array of 3 dB couplers, which is not currently practical. One proposal to overcome this limitation is to use squeezed state sources and Gaussian sampling However, all of these proposals lack a method to input and output low loss quantum photons. Accordingly, embodiments of the present disclosure are directed to a quantum circuit using polarization control inputs to fiber loops to achieve this, as disclosed herein.

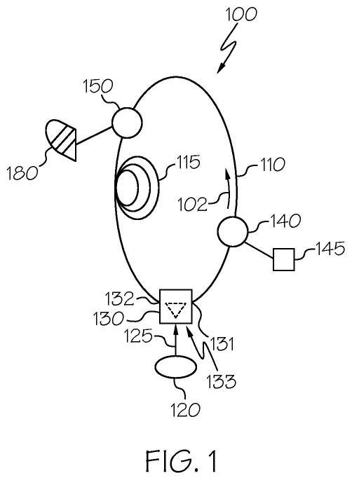

Turning now to the figures, FIG. 1 schematically depicts an example quantum circuit 100. The quantum circuit 100 comprises a fiber loop 110 formed from optical fiber. The fiber loop 110 may enable quantum walks in the time domain, as disclosed herein. Use of a fiber loop to perform quantum walks is an alternative to performing quantum walks in the space domain using passive planar circuits. There are several advantages of loop-based quantum walks including graphic connectivity and low loss. The quantum circuit 100 also enables a simpler configuration with fewer quantum sources than planar circuits. In particular, a single source may emit a train of photons in time rather than an array of quantum sources emitting multiple photons simultaneously.

In the example of FIG. 1, a single photon may be input to the fiber loop 110 and the single photon may traverse around the fiber loop 110 in the propagation direction 102. If the photon remains in the fiber loop 110, the photon may traverse the fiber loop 110 multiple times. As such, a train of photons may be input to the fiber loop 110, with each photon being input at subsequent time steps. Thus, as each subsequent photon is input to the fiber loop 110, it may interact with photons that were input to the fiber loop 110 during previous time steps. As these photons interact, they may create quantum superpositions, which may be measured by a detector. The detected results may be used to calculate parameters for quantum simulation.

In the example of FIG. 1, photons are input to the fiber loop 110 from a quantum source 120 via an input pathway 125. In some examples, the quantum source 120 outputs single photons. In other examples, the quantum source 120 outputs pairs of entangled photons. In still other examples, the quantum source 120 outputs a squeeze state of photons. In some examples, the quantum source 120 outputs a train of squeezed optical pulses. In some examples, the squeezed optical pulses may be about 100 psecs in temporal width and may be separated by about 1 nsec. However, in other examples, the squeezed optical pulses may have other temporal widths and/or temporal separations.

In the example of FIG. 1, the quantum source 120 is optically coupled to a polarization dependent coupler 130, which is optically coupled to the fiber loop 110. In some examples, the polarization dependent coupler 130 may be a 3 dB coupler. The polarization dependent coupler 130 may comprise a first loop end 131, a second loop end 132, and a portal end 133. The first loop end 131 and the second loop end 132 may be optically coupled to the fiber loop 110 and the portal end 133 may be optically coupled to the quantum source 120. As such, the quantum source 120 may input photons to the fiber loop 110 through the polarization dependent coupler 130.

As used herein, “optically coupled” refers to two or more components arranged such that photon pulses and/or quantum states may be transferred therebetween. For example, optical pathways may optically couple the components of the quantum circuit 100 in the example of FIG. 1. The optical pathways may comprise free space, free space in combination with collection optics such as lenses or the like, and/or optical waveguides such as an optical fiber comprising a core and a cladding surrounding the core, a planar waveguide, or the like.

In the example of FIG. 1, the polarization dependent coupler 130 may direct photons having a first polarization (e.g, p-polarization) between the portal end 133 and the first loop end 131 and between the second loop end 132 and the portal end 133. That is, the polarization dependent coupler 130 may cause photons having the first polarization to enter or exit the fiber loop 110. Furthermore, the polarization dependent coupler 130 may direct photons having a second polarization (e.g., s-polarization) between the second loop end 132 and the first loop end 131. Thatis, the polarization dependent coupler 130 may cause photons having the second polarization to stay in the fiber loop 110.

As such, input of photons to the fiber loop 110 may be controlled via polarization. However, if a photon having the first polarization is input to the fiber loop 110 through the polarization dependent coupler 130, and it traverses once around the fiber loop 110 without changing its polarization, then when it reaches the polarization dependent coupler 130, it will still have the first polarization and will exit the fiber loop 110 through the polarization dependent coupler 130. As such, the photon will only travel around the fiber loop 110 once and will have minimal time to interact with other photons to create superpositions that can be measured for quantum simulation.

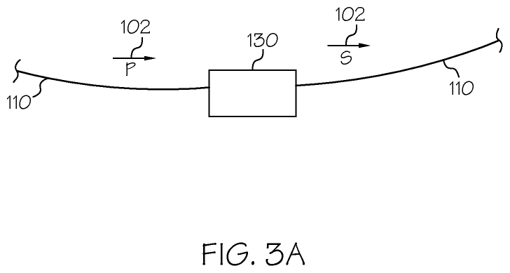

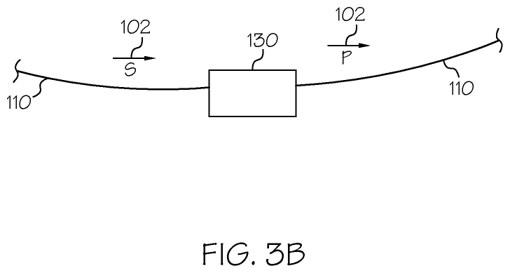

Thus, in the example of FIG. 1, the quantum circuit 100 may comprise a polarization controller 140. The polarization controller 140 may switch the polarization of a photon traversing the fiber loop 110. For example, the polarization controller 140 may switch the polarization of a photon from p-polarization to s-polarization, as shown on FIG. 3A, or from s-polarization to p-polarization, as shown in FIG. 3B.

Thus, after a photon having the first polarization is input to the fiber loop 110 through the polarization dependent coupler 130, when the photon reaches the polarization controller 140, the polarization of the photon may be switched to the second polarization. Then, when the photon reaches the polarization dependent coupler 130 after a first pass through the fiber loop 110, it will stay in the fiber loop 110 since it has the second polarization at that time.

This may allow a photon to traverse the fiber loop 110 twice instead of once before exiting the fiber loop 110. However, when the photon reaches the polarization controller 140 a second time during a second pass around the fiber loop 110, the polarization controller 140 may switch the polarization of the photon from the second polarization back to the first polarization. Accordingly, when the photon reaches the polarization dependent coupler 130 after a second pass around the fiber loop 110, it may exit the fiber loop 110 through the polarization dependent coupler 130, thereby preventing the photon from traversing the fiber loop 110 a third time.

Therefore, in the example of FIG. 1, an electronic switch 145 may disengage the polarization controller 140. That is, the electronic switch 145 may turn the polarization controller 140 from an on state, where the polarization controller 140 switches the polarization of an incident photon, to an off state, where the polarization controller 140 does not switch the polarization of an incident photon. In particular, the electronic switch 145 may disengage the polarization controller 140 after the photon passes through the polarization controller 140 during its first pass around the fiber loop 110 but before the photon reaches the polarization controller 140 during it second pass around the fiber loop 110. Thus, the electronic switch 145 may be a high-speed switch (e.g., a switch that operates on the order of tens of microseconds).

As described above, a photon having the first polarization may be input from the quantum source 120 through the polarization dependent coupler 130 to the fiber loop 110. The photon may pass through the polarization controller 140 and its polarization may be switched to the second polarization. The electronic switch 145 may then disengage the polarization controller 140 as the photon continues to traverse the fiber loop 110. When the photon reaches the polarization dependent coupler 130, the photon may remain in the fiber loop 110 since it now has the second polarization. Subsequently, when the photon again reaches the polarization controller 140, the photon may remain in the second polarization since the electronic switch 145 has disengaged the polarization controller 140. Therefore, the photon may remain in the fiber loop 110 indefinitely with the second polarization.

In the example of FIG. 1, the quantum circuit 100 may further comprise a delay region 115. The delay region 115 may delay the amount of time it takes for a photon to traverse around the fiber loop 110. Accordingly, the delay region 115 may be used to cause photons to interact with each other when a train of photons is input to the fiber loop 110. In particular, the timing of when each photon of the train of photons is input to the fiber loop 110 and the amount of delay in the delay region 115 may be used to control which photons of the train of photons interact with each other.

In some examples, the delay region 115 may be a fiber delay line. In other examples, the delay region 115 may be a quantum memory. While not intending to be limited by theory, each quantum memory is structurally configured to, upon receipt of a photon pulse (e.g., a photon pulse representing a 1-state of a qubit), absorb a photon via a non-linear optical process thereby exciting an atomic ensemble state of the quantum memory from a first energy state, such as a ground state, into a second energy state, such as a non-ground state, for example, an excited state. As used herein, “atomic ensemble state” refers to the arrangement of energy states of the atoms that comprise the quantum memory. As a non-limiting example, in the first energy state, the electrons of the quantum memory may be in a ground state and in the second energy state, some of those electrons may move into an excited state. In some embodiments, the first energy state may have a lower total energy than the second energy state. While still not intending to be limited by theory, the atomic ensemble state of each quantum memory may return to the first energy state after a period of time, without an outside stimulus, orupon receipt of an outside stimulus, such as a control signal received from the controller. Upon return to the first energy state, a photon is released.

Each quantum memory may comprise any known or yet to be developed quantum memory, such as a quantum memory based on an atomic frequency comb (AFC) atomic ensemble or a quantum memory based on a controlled reversible inhomogeneous broadening (CRIB) atomic ensemble. Using each of these atomic ensembles, individual quantum states may be absorbed in such a manner that the quantum state of the received qubit is preserved by the atomic ensemble and can be released as a released photon or null state that shares quantum states with the corresponding received photon or null state. For example, the released photon may be released upon request (e.g., upon receipt of a control signal of the controller) or after a set delay.

Some example quantum memories are described in Sangouard et al., “Quantum Repeaters Based on Atomic Ensembles and Linear Optics”; Review of Modern Physics, vol. 83 January-March 2011; pp. 33-80, in which quantum memories are used in quantum repeaters to enable entanglement swapping. Other example quantum memories include the quantum memory systems described in U.S. Pat. Pub. No. 2018/0322921 titled “Quantum Memory Systems and Quantum Repeater Systems Comprising Doped Polycrystalline Ceramic Optical Devices and Methods of Manufacturing the Same,” assigned to Corning Incorporated of Corning, New York. Other example quantum memories may be realized in microwave or radio frequencies (RF), where an electromagnetic field of photons is used as an elemental carrier of information along waveguides (e.g., metallic, superconducting waveguides). An example of this approach is described in Moiseev et al., “Broadband Multiresonator Quantum Memory-Interface,” Scientific Reports 8:3982 (2018). Other example quantum memories may be realized using microresonators for photons in optical and/or telecommunication wavelength ranges. Furthermore, some example quantum memories may convert optical photons to microwave photons and back. An example of this approach is described in Williamson et al., “Magneto-Optic Modulator with Unit Quantum Efficiency,” Phys. Rev. Lett. 113, 203601, Nov. 14, 2014.

Referring still to FIG. 1, the quantum circuit 100 may comprise a detector 180 and a detector coupler 150 that optically couplesthe fiber loop 110 to the detector 180. The detector 180 may detect photons that exit the fiber loop 110 through the detector coupler 150. The detector 180 may comprise a single photon detector, such as a superconductingnanowire single photon detector, a carbon nanowire detector, an avalanche photodiode detector, a low dark count photodiode detector, or the like.

The detector coupler 150 may allow photons in the fiber loop 110 to exit the fiber loop 110 and reach the detector 180 with a certain probability (e.g., 5%). In some examples, the detector coupler 150 may be tunable such that the probability of photons exiting the fiber loop 110 and reaching the detector 180 may be changed between experiments. As photons are detected by the detector 180, the detected results may be used to calculate parameters to perform quantum simulation.

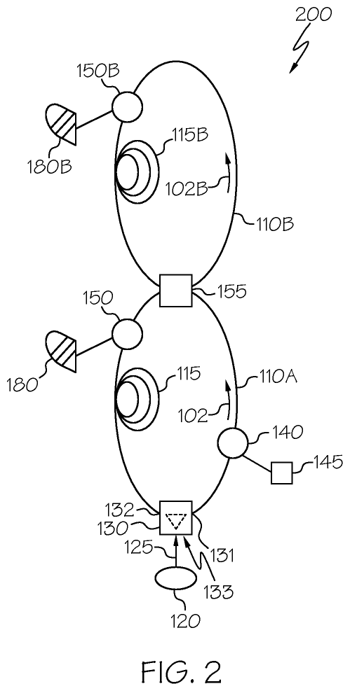

Turning now to FIG. 2, an example quantum circuit 200 is schematically depicted. In the example of FIG. 2, the quantum circuit 200 comprises a first fiber loop 110A and a second fiber loop 110B. The first fiber loop 110A may be constructed similarly to the fiber loop 110 of FIG. 1. The second fiber loop 110B may comprise a second delay region 115B, similar to the delay region 115 of FIG. 1, a second detector coupler 150B, similar to the detector coupler 150 of FIG. 1, and a second detector 180B, similar to the detector 180 of FIG. 1.

The first fiber loop 110A may be optically coupled to the second fiber loop 110B by a fiber loop coupler 155 (e.g., a 3 dB coupler). Accordingly, as photons traverse around the first fiber loop 110A, they may enter the second fiber loop 110B via the fiber loop coupler 155 and traverse around the second fiber loop 110B along the propagation direction 102B. The fiber loop coupler 155 may allow photons to traverse from the first fiber loop 110A to the second fiber loop 110B with a certain probability. In some examples, the fiber loop coupler 155 may be tunable such that the probability of a photon traversing from the first fiber loop 110A to the second fiber loop 110B may be changed between experiments. In some examples, the fiber loop coupler 155 may be controlled programmatically such that a series of experiments may be run in which the probability of photons traversing from the first fiber loop 110A to the second fiber loop 110B is different for each experiment.

The two fiber loops 110A and 110B of the quantum circuit 200 allow more types of photon interactions than are possible with the single fiber loop 110 of the quantum circuit 100 of FIG. 1. In particular, the quantum circuit 200 allows the same types of photon interactions to be measured as with a planar array of waveguides. However, in the example of FIG. 2, the quantum circuit 200 causes the photon interactions to occur in time rather than in space, as in a planar array. In the example of FIG. 2, photons in the first fiber loop 110A may be detected by the detector 180 and photons in the second fiber loop 110B may be detected by the detector 108B. Detection of the photons in the first and second fiber loops 110A and 110B may be used to calculate parameters to perform quantum simulation.

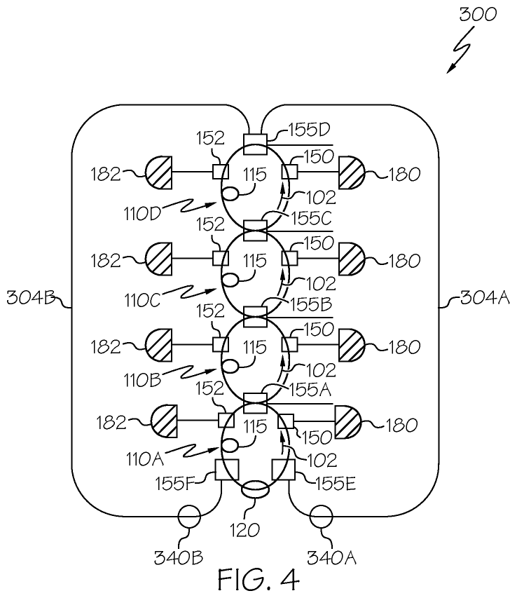

Turning now to FIG. 4, an example quantum circuit 300 is schematically depicted. In the example of FIG. 4, the quantum circuit 300 comprises four fiber loops 110A, 110B, 110C, and 110D. However, in other examples, a quantum circuit may contain any number of fiber loops. Having additional fiber loops allows photons to remain in the quantum circuit 300 longer and may allow for more complex interactions between photons that may be used to calculate parameters for quantum simulation.

In the example of FIG. 4, the fiber loop 110A is optically coupled to the fiber loop 110B by a fiber loop coupler 155A, the fiber loop 110B is optically coupled to the fiber loop 110C by a fiber loop coupler 155B, and the fiber loop 110C is optically coupled to the fiber loop 110D by a fiber loop coupler 155C. In addition, a fiber loop coupler 155D optically couples the fiber loop 110D to outside fiber loops 304A and 304B, which are optically coupled to the fiber loop 100A by fiber loop couplers 155E and 155F. Each of the fiber loop couplers 155A, 155B, 155C, 155D, 155E, 155F may be similar to the fiber loop coupler 155 of FIG. 2. In some examples, each of the fiber loop couplers 155A, 155B, 155C, 155D, 155E, 155F may be tunable such that the probability of a photon traversing from one fiber loop to another may be adjusted.

In the example of FIG. 4, a quantum source 120 may input photons to the fiber loop 110A in a similar manner as the quantum source 120 of FIG. 1. An input photon may traverse around the fiber loop 110A in propagation direction 102 and may exit the fiber loop 110A and enter the fiber loop 110B through the fiber loop coupler 155A. A photon in the fiber loop 110B may traverse around the fiber loop 110B in propagation direction 102 and may exit the fiber loop 110B and enter the fiber loop 110C through the fiber loop coupler 155B. A photon in the fiber loop 110C may traverse around the fiber loop 110C in propagation direction 102 and may exit the fiber loop 110C and enter the fiber loop 110D through the fiber loop coupler 155C. A photon in the fiber loop 100D may traverse around the fiber loop 110D in propagation direction 102 and may exit the fiber loop 100D through the fiber loop coupler 155D, may traverse one of the outside fiber loops 304A or 304B, and may re-enter the fiber loop 100D through one of the fiber loop couplers 155E or 155F.

In the example of FIG. 4, polarization controllers 340A and 340B are positioned along the outside fiber loops 304A and 304B, respectively. The polarization controllers 340A and 340B may be similar to the polarization controller 340 of FIG. 1. In particular, the polarization controllers 340A and 340B may switch a polarization of an incident photon.

Each of the fiber loops may contain a delay region 115 similar to the delay region 115 of FIG. 1. Each of the delay regions may be a fiber delay line or a quantum memory. In the example of FIG. 4, each of the fiber loops 110A, 110B, 110C, 110D are optically coupled to detectors 180 and 182 by detector couplers 150 and 152, respectively. However, in some examples, one or more of the fiber loops 100A, 100B, 110C, 100D may contain a single detector rather than two detectors. The detectors 180 and 182 of FIG. 4 may be similar to the detector 180 of FIG. 1 and the detector couplers 150 and 152 may be similar to the detector coupler 150 of FIG. 1. In the example of FIG. 4, the detectors 180, 182 may detect photons that may be used to calculate parameters for quantum simulation.

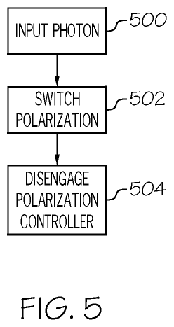

Turning now to FIG. 5, an example method of operating the quantum circuit 100 of FIG. 1 is depicted. At step 500, the quantum source 120 produces a photon which is input to the fiber loop 110 via the input pathway 125 through the polarization dependent coupler 130. The photon produced by the quantum source 120 has a first polarization such that the photon traverses through the polarization dependent coupler 130 and into the fiber loop 110.

At step 502, as the photon input by the quantum source 120 travels around the fiber loop 110, the polarization controller 140 switches the polarization of the photon. In particular, the polarization controller 140 switches the polarization of the photon from the first polarization to a second polarization such that the photon travels through the polarization dependent coupler 130 and remains in the fiber loop 110.

At step 504, the electronic switch 145 disengages the polarization controller 140. In particular, the electronic switch 145 disengages the polarization controller 140 prior to the second pass of the photon through the polarization controller 140 such that the photon remains in the second polarization.

For the purposes of describing and defining the present inventive technology, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” in a particular way, to embody a particular property, or function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

For the purposes of describing and defining the present inventive technology it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present inventive technology, it is noted that this term is introduced in the claims as an open-ended transitional phrase that is used to introduce a recitation of a series of characteristics of the structure and should be interpreted in like manner as the more commonly used open-ended preamble term “comprising.”

1. A quantum circuit comprising:
a polarization dependent coupler optically coupled to a quantum source and a fiber loop;
a polarization controller optically coupled to the fiber loop, wherein the polarization controller is configured to switch a polarization of a photon traversing the fiber loop; and
a detector coupler optically coupled to the fiber loop and optically coupled to a photon detector.

2. The quantum circuit of claim 1, further comprising an electronic switch to disengage the polarization controller.

3. The quantum circuit of claim 1, wherein the fiber loop is optically coupled to both a first loop end of the polarization dependent coupler and a second loop end of the polarization dependent coupler.

4. The quantum circuit of claim 3, wherein:
the polarization dependent coupler further comprises a portal end optically coupled to the quantum source;
the polarization dependent coupler is configured to direct photons comprising a first polarization between the portal end and the first loop end and between the second loop end and the portal end; and
the polarization dependent coupler is configured to direct photons comprising a second polarization between the second loop end and the first loop end.

5. The quantum circuit of claim 1, wherein the fiber loop comprises a delay region.

6. The quantum circuit of claim 5, wherein the delay region comprises a fiber delay line.

7. The quantum circuit of claim 5, wherein the delay region comprises a quantum memory.

8. The quantum circuit of claim 7, wherein the quantum memory is configured to absorb a photon representing a quantum state and release a photon comprising the quantum state of the absorbed photon.

9. The quantum circuit of claim 1, wherein the quantum source is a single photon source.

10. The quantum circuit of claim 1, wherein the quantum source is a multi-photon source configured to output pairs of entangled photons.

11. The quantum circuit of claim 1, wherein the quantum source is configured to output a train of squeezed optical pulses.

12. The quantum circuit of claim 1, wherein the fiber loop comprises a first fiber loop and the quantum circuit further comprises a second fiber loop optically coupled to the first fiber loop by a fiber loop coupler.

13. The quantum circuit of claim 12, wherein the second fiber loop comprises a second detection coupler optically coupled to the second fiber loop and optically coupled to a second photon detector.

14. The quantum circuit of claim 12, wherein the second fiber loop comprises a second delay region.

15. A method of controlling photon propagation in a quantum circuit, comprising:
directing a photon comprising a first polarization from a quantum source through a polarization dependent coupler and into a fiber loop,
switching the polarization of the photon from the first polarization to a second polarization, using a polarization controller that is optically coupled to the fiber loop, during a first pass of the photon through the polarization controller such that the photon travels through the polarization dependent coupler and remains in the fiber loop for a second pass through the polarization controller; and
disengaging the polarization controller prior to the second pass of the photon through the polarization controller such that the photon remains in the second polarization.

16. The method of claim 15, further comprising delaying the photon using a delay region of the fiber loop between the first pass and the second pass of the photon through the polarization controller.

17. The method of claim 15, further comprising:
directing the photon from the fiber loop to a photon detector using a detector coupler optically coupled to the fiber loop; and
measuring a quantum property of the photon using the photon detector.

18. The method of claim 15, wherein the fiber loop is a first fiber loop that is optically coupled to a second fiber loop by a fiber loop coupler and the method further comprises directing the photon from the first fiber loop to the second fiber loop using the fiber loop coupler.

19. The method of claim 15, wherein the fiber loop is optically coupled to both a first loop end of the polarization dependent coupler and a second loop end of the polarization dependent coupler.

20. The method of claim 19, wherein:
the polarization dependent coupler further comprises a portal end optically coupled to the quantum source;
the polarization dependent coupler is configured to direct photons comprising the first polarization between the portal end and the first loop end and between the second loop end and the portal end; and
the polarization dependent coupler is configured to direct photons comprising the second polarization between the second loop end and the first loop end.
